(19) United States
(12) Patent Application Publication
(10) Pub. No.: US 2015/0040571 A1
(43) Pub. Date: Feb. 12, 2015

(54) METHOD FOR FUEL SPLIT CONTROL TO A GAS TURBINE USING A MODIFIED TURBINE FIRING TEMPERATURE

(71) Applicant: General Electric Company, Schenectady, NY (US)

(72) Inventor: Nilanjan Prosad Coomar, Bangalore (IN)

(73) Assignee: General Electric Company, Schenectady, NY (US)

(21) Appl. No.: 13/960,907

(22) Filed: Aug. 7, 2013

(51) Int. Cl. F02C 9/28

(52) U.S. Cl. CPC F02C 9/28
USPC 60/772; 60/734; 60/746

(57) ABSTRACT

A method for controlling fuel splits to a controller is provided that includes comparing a combustor operating parameter to a predefined combustor operating parameter range. If the combustor operating parameter is outside its respective range, then a modified turbine firing temperature is calculated. The modified turbine firing temperature may then be used to determine the fuel splits to the combustor using a nominal fuel splits lookup table.

### FIELD OF THE INVENTION

The present disclosure relates generally to a method for controlling fuel splits in a gas turbine, or more particularly, for controlling fuel splits in a gas turbine based on one or more operating parameters.

### BACKGROUND OF THE INVENTION

Industrial and power generation gas turbines have turbine control systems (controllers) that monitor and control their operation. These controllers govern the combustion system of the gas turbine and other operational aspects of the turbine. Thus, the controller may execute scheduling algorithms that adjust the fuel flow, combustor fuel splits (i.e., the division of the total fuel flow into gas turbine between the various fuel circuits of the turbine), angle of the inlet guide vanes (IGVs) and other control inputs to ensure safe and efficient operation of the gas turbine. Additionally, turbine controllers may receive input values of measured operating parameters and desired operating settings that, in conjunction with scheduling algorithms, determine settings for control parameters to achieve a desired operation. The values prescribed by scheduling algorithms for the control parameters may cause the turbine to operate at a desired state, such as at a desired output level and/or within defined emissions limits.

Generally, the controller schedules the fuel splits for the combustor at each desired output level (e.g., part-load or full load) to ensure that the gas turbine operates within established operational boundaries, such as for combustion dynamics and emissions. The combustor fuel splits can greatly influence the production of harmful emissions, such as carbon-monoxide (CO) and nitrogen-oxides (NOₓ). Additionally, the fuel splits can greatly influence the amount of combustion dynamics, or pressure oscillations in the combustion chamber, that can cause hardware damage in the combustion chamber. Thus, proper scheduling of the fuel splits is often essential in maintaining the gas turbine within emissions compliance and within a safe range of combustion dynamics.

Typically, the scheduling algorithms for the controller utilize a nominal fuel split lookup table to determine the proper combustor fuel splits, based on a calculated reference turbine firing temperature (TTRF). As is generally known, TTRF values are calculated using various measured parameters, such as compressor discharge pressure, turbine exhaust temperature, exhaust air flow, ambient temperature, and IGVs, as inputs. The TTRF calculation is used, e.g., as a means of monitoring the output level of the gas turbine. Thus, as the output level of the gas turbine is adjusted, the calculated TTRF value increases and decreases accordingly. While the turbine is running at a certain output, the controller may therefore determine the TTRF and utilize the nominal fuel split table to determine the appropriate fuel splits for the gas turbine combustor.

The nominal fuel split table values are generally based on nominal values of gas turbine operating parameters, such as compressor inlet temperature (CTIM), IGVs, ambient humidity, fuel composition and temperature, etc. However, when utilizing a lookup table that is static for a given output level to determine fuel splits, such as the nominal fuel split table based on TTRF, rigid standards must often be set for operating conditions of the gas turbine. This is due to the fact that the calculated TTRF value used in the lookup table for fuel splits does not adequately account for any deviations in the above operating conditions. Unfortunately, the operating conditions of a gas turbine are often dynamic, such that the operating conditions frequently change during operation relative to the nominal values. As the operating conditions vary from nominal conditions, the emissions and combustion dynamics may be adversely affected.

Accordingly, a method for controlling fuel splits to a gas turbine combustor that may account for varying operating parameters at a given output or calculated TTRF value would be useful. More specifically, such a method that could simply and efficiently account for varying operating parameters would be beneficial.

### BRIEF DESCRIPTION OF THE INVENTION

The present disclosure provides a method for controlling fuel splits to a controller that includes comparing a combustor operating parameter to a predefined combustor operating parameter range. If the combustor operating parameter is outside its respective range, then a modified turbine firing temperature is calculated. The modified turbine firing temperature may then be used to determine the fuel splits to the combustor using a nominal fuel splits lookup table. Additional aspects and advantages of the disclosure will be set forth in part in the following description, or may be obvious from the description, or may be learned through practice of the disclosure.

In one exemplary aspect of the present disclosure, a method is provided for controlling fuel splits to a combustor of a gas turbine. The method includes determining a reference turbine firing temperature of the gas turbine, monitoring a combustor operating parameter, and comparing the combustor operating parameter to a predefined combustor operating parameter range. The method additionally includes computing a modified turbine firing temperature as a function of the combustor operating parameter if the combustor operating parameter is outside of the predefined combustor operating parameter range. Furthermore, the method includes determining the fuel splits to the combustor based on the modified turbine firing temperature and a nominal fuel splits lookup table.

In one exemplary embodiment of the present disclosure, a system for controlling a gas turbine is provided, including a computing device which includes a processor and memory storing instructions. When the instruction are implemented by the processor, the instructions configure the computing device to determine a reference turbine firing temperature of the gas turbine, monitor a combustor operating parameter, and compare the combustor operating parameter to a predefined combustor operating parameter range. The instruction also configure the computing device to compute a modified turbine firing temperature as a function of the combustor operating parameter if the combustor operating parameter is outside of the predefined combustor operating parameter range. Furthermore, the instructions configure the computing device to determine the fuel splits to the combustor based on the modified turbine firing temperature and a nominal fuel splits lookup table.

In another exemplary embodiment of the present disclosure, a turbine system is provided, the system including a compressor inlet for receiving a fluid and a compressor positioned downstream of the compressor inlet for compressing the fluid. The system may also include a turbine coupled to the compressor, a combustor having one or more fuel nozzles, and a controller. The controller may include a computing device including a processor and memory storing instructions. When the instruction are implemented by the processor, the instructions configure the computing device to determine a reference turbine firing temperature of the gas turbine, monitor a combustor operating parameter, and compare the combustor operating parameter to a predefined combustor operating parameter range. The instruction also configure the computing device to compute a modified turbine firing temperature, modified as a function of the combustor operating parameter, if the combustor operating parameter is outside of the predefined combustor operating parameter range. Furthermore, the instructions configure the computing device to determine the fuel splits to the combustor based on the modified turbine firing temperature if the combustor operating parameter is outside the predefined operating parameter range and a nominal fuel splits lookup table.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWING

A full and enabling disclosure of the present disclosure, including the best mode thereof, directed to one of ordinary skill in the art, is set forth in the specification, which makes reference to the appended figures, in which:

FIG. 1 provides a schematic drawing of an exemplary embodiment of a gas turbine of the present disclosure.

FIG. 2 provides an exemplary embodiment of a nominal fuel splits lookup table.

FIG. 3 provides an exemplary embodiment of a method for controlling fuel splits to a gas turbine in accordance with aspects of the present disclosure.

FIGS. 4A through 4G provide exemplary embodiments of shift value lookup tables for various combustor operating parameters.

### DETAILED DESCRIPTION OF THE INVENTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

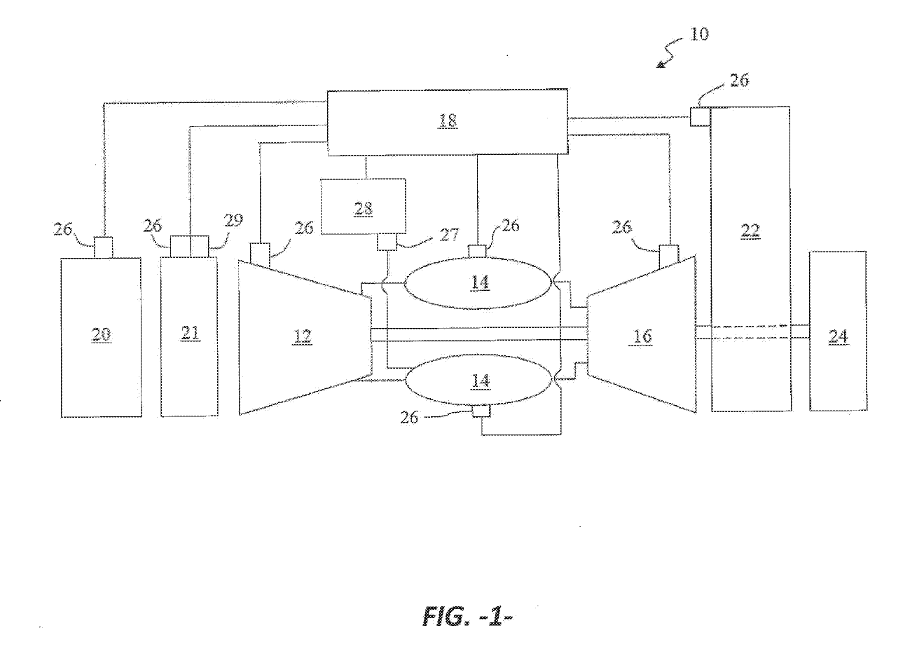

Referring to the drawings, FIG. 1 illustrates a schematic view of an exemplary embodiment of a gas turbine 10 having a compressor 12, a plurality of combustors 14, a turbine 16 drivingly coupled to compressor 14, and a turbine control system 18 (hereinafter referred to as the “controller”). In one embodiment, the combustors 14 may be part of a Dry-Low NOx (DLN) combustion system and the controller 18 may be programmed and/or modified to control the DLN combustion system. An inlet duct 20 to the compressor 14 feeds ambient air and possibly injected water into the compressor 14. The ambient air entering inlet duct 20 may have a temperature, known as the compressor inlet temperature (CTIM), and a humidity, referred to herein as RH.

A first stage of compressor 14 may include a plurality of circumferentially arranged cantilevered inlet guide vanes 21 (IGVs). IGVs 21 define an IGV angle and are coupled to an actuator 29. Actuator 29 may adjust the IGV angle and may be controlled by controller 18 so as to regulate airflow flowing through compressor 14. For example, during base-load operation, IGVs 21 may be actuated to a fully open position, such as at an IGV angle of approximately 90 degrees, to allow maximum airflow through compressor 14. However, during part-load operation, the IGVs may be set to a more closed position, such as at an IGV angle of less than about 54 degrees, to reduce airflow through the compressor 14. An exhaust duct 22 of the gas turbine 10 directs combustion gases from the outlet of turbine 16 through, for example, emission control and sound absorbing devices. Additionally, turbine 16 may drive a generator 24 that produces electrical power.

Gas turbine 10 may also include a plurality of fuel circuits configured to deliver fuel to the various fuel nozzles within the combustors 14. For example, in one exemplary embodiment, gas turbine 10 may include four fuel circuits, with three fuel circuits delivering fuel to the various premix fuel nozzle assemblies (e.g., PM1, PM2 and PM3 fuel circuits) and a diffusion fuel circuit delivering fuel to various fuel nozzles via diffusion fuel passages (D5 fuel circuit). It should be appreciated, that gas turbine 10 may include any number and type of fuel circuits depending on the configuration of gas turbine 10 and, thus, need not have the same number and type fuel circuits described above. Additionally, depending on the particular mode at which a gas turbine 10 is operating, it should be appreciated that fuel may not be supplied through each of the fuel circuits. For example, during part-load operation, fuel may only be delivered to combustors 14 through the PM1, PM2 and PM3 fuel circuits.

A fuel controller 28 may regulate the fuel flowing from a fuel supply to the combustor 14. The fuel controller 28 may also select the type of fuel for the combustor. Additionally, the fuel controller 28 may generate and implement fuel split commands that determine the portion of fuel flowing to the various fuel circuits of the combustor 12. Generally, the fuel split commands correspond to a fuel split percentage for each fuel circuit, which defines what percentage of the total amount of fuel delivered to the combustor is supplied through a particular fuel circuit (e.g., the percentage of the total fuel flow being supplied to the PM1, PM2 and PM3 fuel circuits). It should be appreciated that the fuel controller 28 may comprise a separate unit or may be a component of the turbine controller 18.

The operation of gas turbine 10 may be monitored by several sensors 26 detecting various conditions of the turbine, generator and ambient environment. For example, temperature sensors 26 may monitor the ambient temperature of the air entering the inlet duct 20 of compressor 12 (CTIM), the compressor discharge temperature, the turbine exhaust gas temperature, the fuel temperature, and other temperature measurements of the working fluid and combustion gases through the gas turbine. Pressure sensors 26 may monitor ambient pressure and static and dynamic pressure levels at the compressor inlet and outlet, turbine exhaust, and at other locations in the gas stream through gas turbine 10. Further, pressure sensors 26 may be positioned so as to be able to measure the combustor dynamics within combustors 14. Pressure sensors 26 may measure the cold tone dynamics, e.g., the combustor dynamics having a frequency between 70 Hz and 120 Hz, and the hot tone combustor dynamics, e.g., the combustor dynamics having a frequency between 120 Hz and 160 Hz.

Humidity sensors 26 (e.g., wet and dry bulb thermometers) may measure ambient humidity (RH) at inlet duct 20 of compressor 12. One or more IGV sensors 26 monitor or identify the angle of the IGVs 21. Sensors 26 may also monitor fuel composition sent to combustor 12 by fuel controller 28, as measured by the fuel's Modified Wobbe Index (MWI) value. Sensors 26 may directly measure the MWI value of the fuel, or may monitor certain properties so as to allow controller 18 to calculate the MWI value of the fuel. As is generally known by those skilled in the art, MWI is used as a measure of the interchangeability of gas fuels for a given system design.

Emissions sensors 26 may measure the emissions from exhaust duct 22 of gas turbine 10. For example, emissions sensors 26 may measure emissions of nitrogen-oxides (NOₓ) and carbon-monoxide (CO). Sensors 26 may also comprise flow sensors, speed sensors, flame detector sensors, valve position sensors, or the like that sense various other operating parameters pertinent to the operation of gas turbine 10. As used herein, “operating parameters” refer to any measure that can be used to define an operating conditions of a gas turbine such as, but not limited to, temperatures, pressures, and gas flows at defined locations in the gas turbine. Some operating parameters may be measured since they are capable of being sensed and may be directly known. Other operating parameters may be estimated or calculated using the measured operating parameters. The measured and calculated operating parameters may generally be used to represent a given turbine operating condition.

Controller 18 may generally be any turbine control system known in the art that permits a gas turbine 10 to be controlled and/or operated as described herein. For example, the controller 18 may comprise a General Electric SPEEDTRONIC™ Gas Turbine Control System, such as is described in Rowen, W.I., “SPEEDTRONIC™ Mark™ V Gas Turbine Control System,” GE-3658D, published by GE Power & Water of Schenectady, N.Y. Generally, controller 18 may comprise any computer system having one or more processor(s) and associated memory device(s) configured to perform a variety of computer-implemented functions to control gas turbine 10. The commands generated by controller 18 may also cause actuators on gas turbine 10 to, for example: adjust valves (actuator 27) between the fuel supply and combustors 14 that regulate the flow, fuel splits and type of fuel flowing to the combustors 14; adjust the angle of the inlet guide vanes 21 (actuator 29) on the compressor 12, and activate other control settings on gas turbine 10. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements.

The scheduling algorithms may generally enable controller 18 to maintain certain operational boundaries of turbine 10. For example, controller 18 may use scheduling algorithms to maintain NOₓ and CO emissions in the turbine exhaust to within certain predefined emission limits, and to maintain the combustor dynamics within a safe operating limit. It should be appreciated that the scheduling algorithms may use various operating parameters as inputs. Controller 18 may then apply the algorithms to schedule gas turbine 10 to, for example, set desired turbine exhaust temperatures and combustor fuel splits. In particular, the scheduling algorithms may utilize a nominal fuel splits lookup table to set the fuel splits to combustor 14 at a given turbine reference firing temperature (TTRF). By varying the fuel splits, controller 18 may comply with the operational boundaries, e.g., emissions and combustor dynamics, while meeting the performance objectives as well.

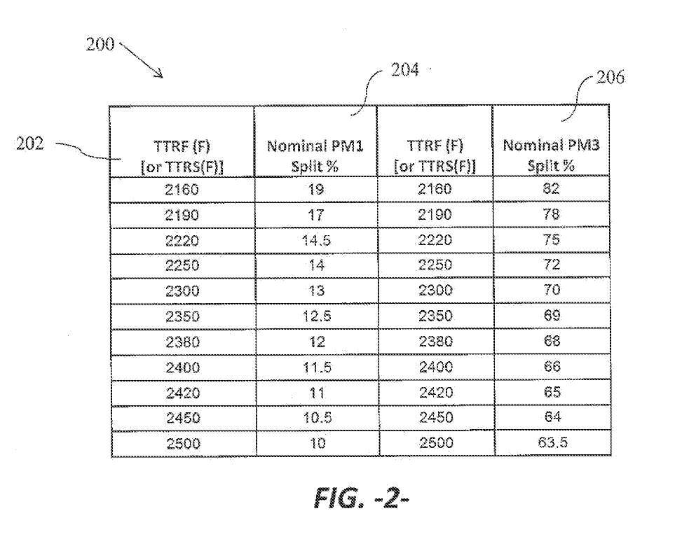

Referring now to FIG. 2, one exemplary embodiment of a nominal fuel split lookup table 200 of the present disclosure is provided, including exemplary nominal fuel split values. As shown, for a given TTRF value 202, table 200 has corresponding exemplary nominal fuel split values for each fuel circuit, e.g., exemplary values for PM1 204 and PM2 206 in the present embodiment. Fuel split values 204, 206 in nominal fuel split lookup table 200 may be determined during testing or tuning of gas turbine 10. The testing or tuning of gas turbine 10 may take place during the initial commissioning of gas turbine 10, or during seasonal retuning of gas turbine 10.

The exemplary fuel split values 204, 206 in nominal fuel split lookup table 200 correspond to the optimal fuel split values under nominal conditions, i.e., normal, or expected, operating conditions of turbine 10. As such, the testing or tuning may take place during a time when the ambient temperature and humidity, corresponding to CTIM and RH, respectively, at the site are representative of the average ambient temperature and humidity at the geographic location of the site where gas turbine 10 is located. Further, the fuel composition, as measured by an MWI value, of the fuel used during the testing or tuning may be what is expected to be used during typical operation of gas turbine 10. Additionally, the IGV angles during the testing or tuning may be set to the expected IGV angles for each respective load during testing or tuning of gas turbine 10. Accordingly, it should be appreciated that the values provided in table 200 of FIG. 2 are by way of example only.

However, the operating parameters of gas turbine 10 may deviate from their nominal values, and as such, a nominal fuel split lookup table 200 driven solely by a calculated TTRF value may not completely account for the variability in the combustor operating parameters of gas turbine 10. For example, gas turbine 10 may be required to operate using fuels having a wide range of MWI values due to, e.g., the geographic availability of certain fuels or other economic factors. Similarly, gas turbine 10 may be required to operate at times when the CTIM value, the RH value, or the IGV angles are much higher or lower than their nominal values. Deviations, such as these, may adversely impact operational factors of combustor 14 of gas turbine 10, as gas turbines are generally very sensitive to changes in operating parameters that may cause fluctuation in air flow and/or fuel flow. Specifically, any such deviation may adversely impact, e.g., combustor dynamics and emissions of NOₓ and CO.

These adverse impacts may be minimized, however, by dynamically adjusting the fuel splits to combustor 14 during operation of turbine 10 so as to account for any deviations in the above combustor operating parameters. Additionally, any adverse impact may be further minimized by closed-loop control of NOₓ emissions and combustor dynamics, or more specifically, by having controller 18 directly monitor these parameters and adjust the fuel splits accordingly.

Accordingly, referring now to FIG. 3, in one exemplary embodiment of the present disclosure, a method 100 for controller 18 to dynamically control the fuel splits to combustor 14 of gas turbine 10 is illustrated. Method 100 requires controller 18 to determine a TTRF value of gas turbine 10 in step 102 and to monitor one or more combustor operating parameters. Method 100 further requires, in steps 104a through 104f, controller to compare the one or more monitored combustor operating parameters to a respective predefined combustor operating parameter range. The predefined combustor operating parameter range is specific to each respective combustor operating parameter, and may be determined during the testing or tuning of combustor 10. For this exemplary embodiment, controller 18 monitors and compares the MWI value of the fuel in step 104a, CTIM in step 104b, IGV angle in step 104c, RH in step 104d, NOₓ emissions in step 104e, and combustor dynamics in step 104f. In alternative exemplary embodiments, however, controller 18 may not monitor all of the above combustor operating parameters. Specifically, in other exemplary embodiments, controller 18 may monitor only one combustor operating parameter, or any combination of the above combustor operating parameters.

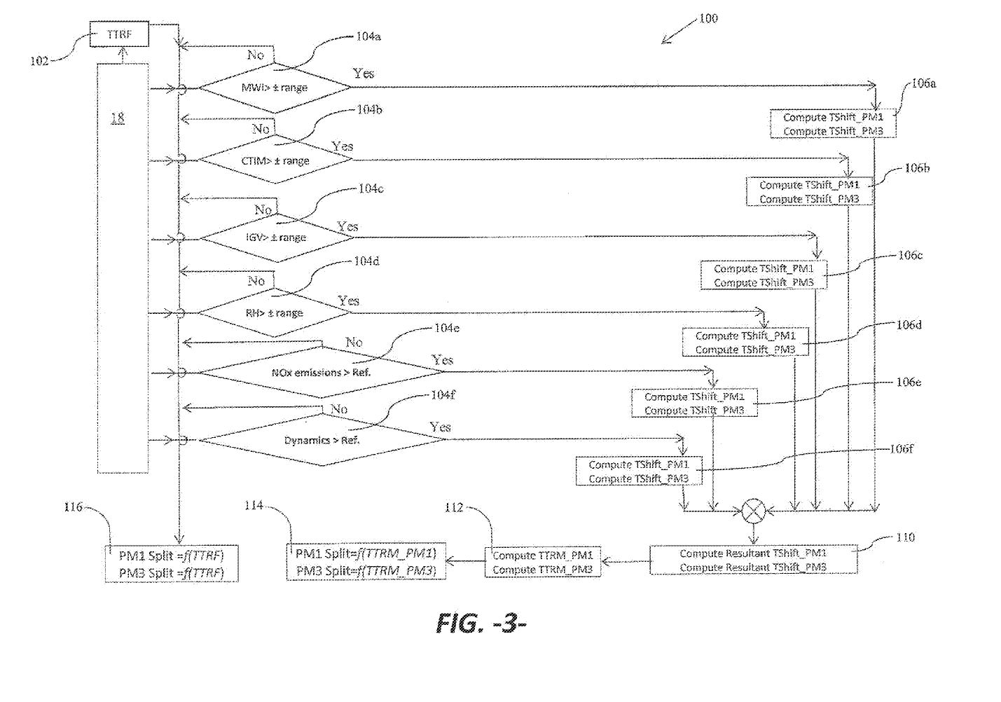

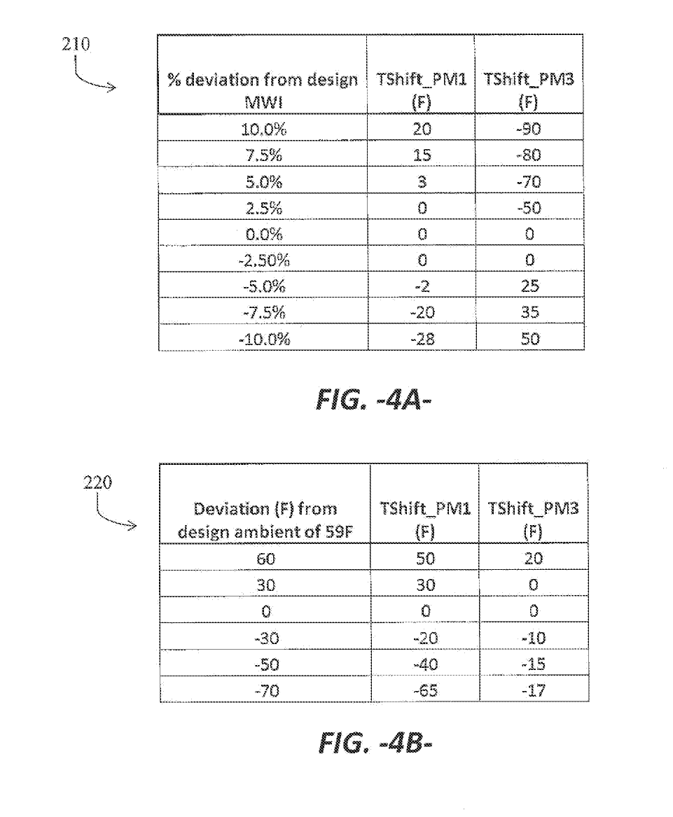

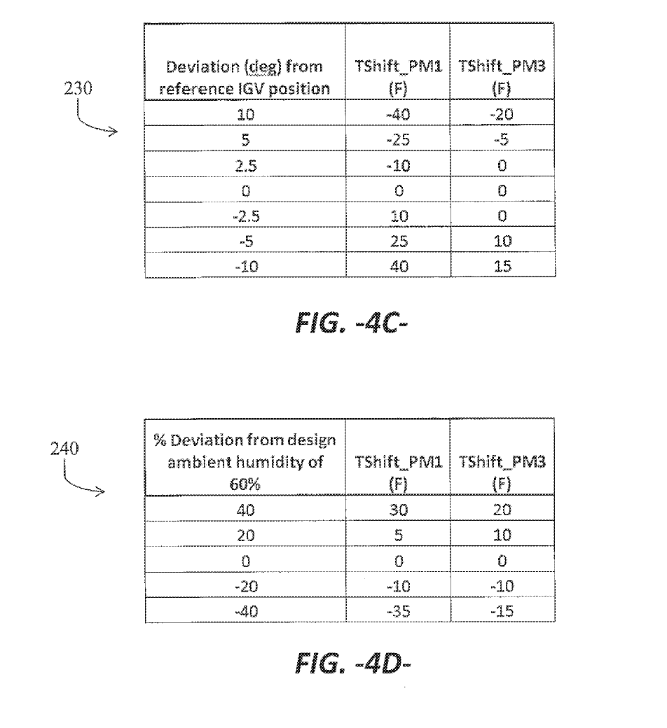

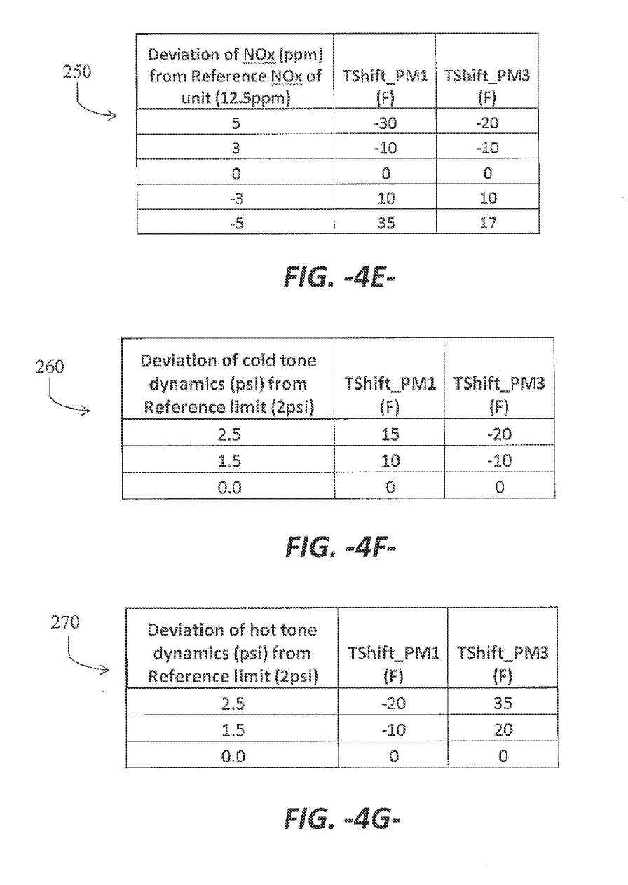

As shown in steps 106a through 106f, controller 18 may then compute a shift value for each fuel circuit and for each monitored combustor operating parameter outside its respective combustor operating parameter range and for each fuel circuit. As is discussed below with reference to FIGS. 4A through 4G, the shift values for each respective operating parameter may be determined by referencing an operating parameter shift lookup table.

Once a shift value is determined for each fuel circuit and for each monitored operating parameter outside its respective operating parameter range, controller 18 calculates a resultant shift value for each fuel circuit in step 110 (e.g., Resultant TShift_PM1, Resultant TShift_PM3). In one exemplary embodiment, controller 18 may add together each of the shift values to determine the resultant shift value for each fuel circuit. In another exemplary embodiment, however, controller 18 may multiply the shift values for one or more operating parameters by a gain factor and then add the values together. In such an embodiment, controller may weight certain operating parameters' shift values more or less heavily when computing the resultant shift value.

Once a resultant shift value is computed for each fuel circuit, in step 112 controller 18 computes a modified turbine firing temperature value (TTRM) for each fuel circuit by adding the resultant shift value determined in step 110 to the TTRF value determined in step 102. The calculation of step 112 may be as follows:

TTRM_{—}PM1=TTRF+Resultant TShift_{—}PM1; and

TTRM_{—}PM3=TTRF+Resultant TShift_{—}PM3.

Controller 18 may then use the TTRM value computed in step 112 for each fuel circuit, in place of TTRF, to determine the split values for each fuel circuit using nominal fuel split lookup table 200. The technical effect of the method 100 of the present disclosure is that controller 18 may more effectively take into account up to six combustor operating parameters so as to allow turbine 10 to operate within operational limits, such as emissions and combustor dynamics limits, while still meeting performance objectives. Additionally, method 100 may be implemented by codifying relatively simple instructions in the memory of controller 18 for processor in controller 18 to implement.

Notably, however, when all monitored operating parameters are within their respective operating parameter ranges, as indicated in FIG. 3, controller 18 still determines the fuel splits to combustor based on TTRF value calculated in step 102 and nominal fuel split lookup table 200.

It should be appreciated that although method 100 of FIG. 3 and nominal fuel split table 200 of FIG. 2 are shown with gas turbine 10 having fuel circuits delivering fuel to two premix fuel nozzle assemblies (PM1 and PM3), in other exemplary embodiments of the present disclosure, any number or configuration of fuel circuits may be present. For example, in an alternative exemplary embodiment, gas turbine 10 may include four fuel circuits, with three fuel circuits delivering fuel to the various premix fuel nozzle assemblies (e.g., PM1, PM2 and PM3 fuel circuits) and a diffusion fuel circuit delivering fuel to various fuel nozzles via diffusion fuel passages (D5 fuel circuit).

Referring now to FIGS. 4A through 4G, exemplary embodiments of shift value tables are provided for various combustor operating parameters. FIG. 4A provides an exemplary shift value table 210 for fuel composition, as measured by an MWI value, as may be used in step 106a of method 100, shown in FIG. 3. Turbine 10 of such an embodiment may be capable of tolerating a deviation greater than plus or minus 5% of a nominal MWI value, such as greater than plus or minus 7.5% of a nominal MWI value, such as greater than plus or minus 9% of a nominal MWI value.

Similarly, FIG. 4B provides an exemplary shift value table 220 for compressor inlet temperature (CTIM), measured in degrees Fahrenheit (F), wherein the nominal CTIM value is 59 degrees F. Table 220 may be used in step 106b of method 100, shown in FIG. 3. Turbine 10 of such an embodiment may be capable of tolerating a deviation greater than plus or minus 30 degrees F. from a nominal CTIM value, such as greater than plus or minus 50 degrees F. from a nominal CTIM.

FIG. 4C provides an exemplary shift value table 230 for IGV angle, as measured in degrees. Table 230 may be used in step 106c of method 100, shown in FIG. 3. Turbine 10 of such an embodiment may be capable of tolerating a deviation greater than plus or minus 5 degrees from a nominal IGV value, such as greater than plus or minus 10 degrees from a nominal IGV value.

FIG. 4D provides an exemplary shift value table 240 for RH, measured in percent humidity, wherein the nominal RH value is 60% humidity. Table 240 may be used in step 106d of method 100, shown in FIG. 3. Turbine 10 of such an embodiment may be capable of tolerating a deviation greater than plus or minus 15% humidity, such as greater than plus or minus 35% humidity.

FIGS. 4E through 4G represent exemplary embodiments of shift value tables 250, 260, and 270 for NOₓ emissions, cold tone combustor dynamics, and hot tone combustor dynamics, respectively. These combustion operating parameters are unique in that they represent closed-loop control of turbine 10 through manipulation of the TTRF value (i.e., calculation of TTRM) to control fuel splits and correct for emissions and combustor dynamics outside the respective reference values.

FIG. 4E provides exemplary embodiment of shift value table 250 for NOₓ emissions in parts per million (ppm), wherein the reference NOₓ emissions are 12.5 ppm. Table 250 may be used in step 106e of method 100, shown in FIG. 3. In such an embodiment, turbine 10 may correct for deviations from the reference NOₓ emissions of greater than plus or minus 3 ppm, such as greater than plus or minus 4 ppm.

Finally, FIGS. 4F and 4G provide exemplary embodiments of shift value tables 260 and 270 for cold tone combustor dynamics and hot tone combustor dynamics, respectively. Cold tone combustor dynamics may include dynamics having a frequency between 70 Hz and 120 Hz, while hot tone combustor dynamics may include dynamics having a frequency between 120 Hz and 160 Hz. As shown, in the exemplary embodiments of tables 260 and 270, the reference limit is 2 psi, and turbine 10 of such an embodiment, may correct for deviations great than 1 psi, such as greater than 2 psi. Tables 260 and 270 may be used in step 106f of method 100, shown in FIG. 3.

It should be appreciated, however, that the values provided in each of FIGS. 4A through 4G are by way of example only. In other exemplary embodiments, the values provided in Tables 210, 220, 230, 240, 250, 260, and 270 may be any other values determined to be appropriate shift values for the respective operating parameter.

Regarding the exemplary embodiment of nominal fuel split lookup table 200, in some instances, the fuel splits values may not be defined for the determined TTRF or TTRM values. In these instances, controller 18 may calculate the fuel splits value by interpolation, based values defined immediately higher and immediately lower than the determined TTRF or TTRM values. Similarly, for the exemplary embodiments of the shift lookup tables provided in FIGS. 4A through 4G, shift values may be interpolated in the instances where a shift value is not defined for a certain deviation.

This written description uses examples to disclose the present subject matter, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for controlling fuel splits to a combustor of a gas turbine, comprising performing the following with a controller:
determining a reference turbine firing temperature of the gas turbine;
monitoring a combustor operating parameter;
comparing the combustor operating parameter to a predefined combustor operating parameter range;
computing a modified turbine firing temperature as a function of the combustor operating parameter if the combustor operating parameter is outside of the predefined combustor operating parameter range; and
determining the fuel splits to the combustor based on the modified turbine firing temperature and a nominal fuel splits lookup table.

2. A method as in claim 1, wherein the combustor operating parameter is any one of, or combination of fuel composition, compressor inlet temperature, ambient humidity, inlet guide vane angle, nitrogen oxides emissions, or combustion dynamics in the combustor.

3. A method as in claim 1, wherein the step of comparing further comprises determining a shift value based on the value of the combustor operating parameter if the combustor operating parameter is outside the predefined combustor operating parameter range, and wherein the step of computing further comprises summing the shift value and the reference turbine firing temperature to determine the modified turbine firing temperature.

4. A method as in claim 1, wherein the combustor operating parameter is fuel composition as measured by a Modified Wobbe Index (MWI) value, and wherein the gas turbine operates using a fuel having an MWI value greater than plus or minus 2.5% of a nominal MWI value.

5. A method as in claim 2, wherein the step of monitoring further comprises monitoring two or more combustor operating parameters, wherein the step of comparing further comprises comparing each of the monitored combustor operating parameters to each respective predefined combustor operating parameter range, and wherein the step of computing further comprises computing a modified their respective combustor operating parameter ranges.

6. A method as in claim 5, wherein the step of comparing further comprises determining a shift value for each combustion operating parameter that is outside of its respective combustor operating parameter range, and wherein the step of computing further comprises summing each of the shift values with the reference turbine firing temperature to determine the modified turbine firing temperature.

7. A method as in claim 6, wherein each of the shift values are weighed equally when calculating the modified turbine firing temperature in the step of computing.

8. A method as in claim 6, wherein one or more of the shift values are multiplied by a gain factor prior to being summed with the rest of the shift values to determine the modified turbine firing temperature in the step of computing.

9. A method as in claim 6, wherein the step of monitoring further comprises monitoring three or more combustion operating parameters.

10. A method as in claim 2, wherein one or more of the combustor operating parameters includes nitrogen oxides emissions or combustion dynamics in the combustor, such that the controller offers closed-loop control of the combustor's nitrogen oxides emissions or combustion dynamics.

11. A method as in claim 1, wherein the step of determining the fuel splits further comprises a step of interpolating a fuel split value when an exact fuel shift value is not defined in the nominal fuel splits table for a computed modified turbine firing temperature.

12. A system for controlling a gas turbine, comprising:
a computing device including a processor and memory storing instructions that, when implemented by the processor, configure the computing device to:
determine a reference turbine firing temperature of the gas turbine;
monitor a combustor operating parameter;
compare the combustor operating parameter to a predefined combustor operating parameter range;
compute a modified turbine firing temperature as a function of the combustor operating parameter, if the combustor operating parameter is outside of the predefined combustor operating parameter range; and
determine the fuel splits to the combustor based on the modified turbine firing temperature and a nominal fuel splits lookup table.

13. A system as in claim 12, wherein the combustor operating parameter is any one of, or combination of, fuel composition, compressor inlet temperature, ambient humidity, inlet guide vane angle, nitrogen oxides emissions, or combustion dynamics in the combustor.

14. A system as in claim 12, wherein the controller is further configured to determine a shift value if the combustor operating parameter is outside the predefined combustor operating parameter range, and compute a modified turbine firing temperature by summing the shift value and the reference turbine firing temperature.

15. A system as in claim 13, wherein the controller is further configured to monitor two or more combustor operating parameters and compare each monitored combustor operating parameters to a predetermined combustor operating parameter range, and determine a shift value for each combustor operating parameter outside its respective combustor operating parameter range.

16. A system as in claim 15, wherein the controller is further configured to compute a modified turbine firing temperature by summing the determined reference turbine firing temperature with the shift values.

17. A system as in claim 16, wherein one of the combustor operating parameters is fuel composition, as measured by a Modified Wobbe Index (MWI) value, and wherein the gas turbine operates using a fuel having an MWI value greater than plus or minus 2.5% of a nominal MWI value.

18. A system as in claim 16, wherein one or more of the shift values are multiplied by a gain factor prior to being summed with the rest of the shift values to determine the modified turbine firing temperature.

19. A system as in claim 12, wherein one or more of the combustor operating parameters includes nitrogen oxides emissions or combustion dynamics in the combustor, such that the controller offers closed-loop control of the combustor's nitrogen oxides emissions or combustion dynamics.

20. A turbine system, comprising:
a compressor inlet for receiving a fluid;
a compressor positioned downstream of the compressor inlet for compressing the fluid;
a turbine coupled to the compressor;
a combustor having one or more fuel nozzles; and
a controller comprising a computing device including a processor and memory storing instructions that, when implemented by the processor, configure the computing device to:
determine a reference turbine firing temperature of the gas turbine;
monitor a combustor operating parameter;
compare the combustor operating parameter to a predefined combustor operating parameter range;
compute a modified turbine firing temperature, modified as a function of the combustor operating parameter, if the combustor operating parameter is outside of the predefined combustor operating parameter range; and
determine the fuel splits to the combustor based on the modified turbine firing temperature if the combustor operating parameter is outside the predefined operating parameter range and a nominal fuel splits lookup table.
